(19) United States
(12) Patent Application Publication
(10) Pub. No.: US 2022/0185026 A1
(43) Pub. Date: Jun. 16, 2022

(54) TIRE WITH UNIQUE HYBRID TERRAIN TREAD

(71) Applicant: American Pacific Industries, Inc., Scottsdale, AZ (US)

(72) Inventors: JEFFREY A. KREITZMAN, Scottsdale, AZ (US); Sunrong Gong, Shanghai (CN); Haipeng Zhao, Weihai (CN)

(21) Appl. No.: 17/122,145

(22) Filed: Dec. 15, 2020

(51) Int. Cl. B60C 11/04; B60C 11/03; B60C 11/11; B60C 11/13

(52) U.S. Cl. CPC B60C 11/045; B60C 11/0309; B60C 2011/0358; B60C 11/1376; B60C 11/11

(57) ABSTRACT

A tire including a plurality of block patterns, wherein the plurality of block patterns may repeat around a circumference of the tire. The tire may further include a three dimensional chambered groove in the plurality of block patterns. The tire may further include a plurality of independent pattern blocks.

### BACKGROUND

Tires may be used on multiple vehicle types (e.g., trucks, cars, trailers, etc.) to help travel under multiple on road/off road conditions. For instance, using trucks as an example, specific designs of tires may be used to help the truck travel under normal conditions, mud conditions, snow conditions, rain conditions, as well as other conditions.

### BRIEF SUMMARY OF DISCLOSURE

In one example implementation, a tire may include but is not limited to a plurality of block patterns, wherein the plurality of block patterns may repeat around a circumference of the tire. The tire may further include a three dimensional chambered groove in the plurality of block patterns. The tire may further include a plurality of independent pattern blocks.

One or more of the following example features may be included. The plurality of block patterns may have an S shape. The plurality of block patterns may be located between a left shoulder and a right shoulder, and wherein one reinforcing rib of the plurality of reinforcing ribs may connect two shoulder blocks. The three dimensional chambered groove may be located in a middle portion of each block pattern of the plurality of block patterns. The three dimensional chambered groove may be most narrow in a middle portion of the three dimensional chambered groove. The plurality of independent pattern blocks may have a wedge shape. The wedge shape may be widest at a top part of the wedge shape and narrowest at a bottom part of the wedge shape. The tire may further include a plurality of reinforcing ribs. The plurality of reinforcing ribs may be located at a bottom portion of a shoulder groove. The tire may further include a sidewall pattern with a thickness between 2.0 mm-4.0 mm. An angle of the pattern block may be between 5°-45°. The sidewall pattern may include at least 3 layers of high modulus low shrinkage polymer cords. The tire may further include a belt steel wire and a double-layer crown belt. The tire may be a bias tire. The tire may be a truck and bus radial tire.

In another example implementation, a tire may include but is not limited to a plurality of block patterns, wherein the plurality of block patterns may repeat around a circumference of the tire. The tire may further include a three dimensional chambered groove in the plurality of block patterns, wherein the three dimensional chambered groove may be located in a middle portion of each block pattern of the plurality of block patterns. The tire may further include a plurality of independent pattern blocks. The tire may further include a plurality of reinforcing ribs located at a bottom portion of a shoulder groove, wherein one reinforcing rib of the plurality of reinforcing ribs may connect two shoulder blocks.

One or more of the following example features may be included. The plurality of block patterns may have an S shape. The plurality of block patterns may be located between a left shoulder and a right shoulder. The three dimensional chambered groove may be most narrow in a middle portion of the three dimensional chambered groove. The plurality of independent pattern blocks may have a wedge shape. The wedge shape may be widest at a top part of the wedge shape and narrowest at a bottom part of the wedge shape. The tire may further include a sidewall pattern with a thickness between 2.0 mm-4.0 mm. An angle of the pattern block may be between 5°-45°. The sidewall pattern may include at least 3 layers of high modulus low shrinkage polymer cords. The tire may further include a belt steel wire and a double-layer crown belt.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a tire according to one or more example implementations of the disclosure;

FIG. 2 is an example diagrammatic view of a tire according to one or more example implementations of the disclosure;

FIG. 3 is an example diagrammatic view of a chambered groove of a tire according to one or more example implementations of the disclosure;

FIG. 4 is an example diagrammatic view of a reinforcing rib of a tire according to one or more example implementations of the disclosure; and

FIG. 5 is an example diagrammatic view of a shoulder design of a tire according to one or more example implementations of the disclosure.

Like reference symbols in the various drawings indicate like elements.

### DETAILED DESCRIPTION

### Overview

Tires may be used on multiple vehicle types (e.g., trucks, cars, trailers, etc.) to help travel under multiple on road/off road conditions. For instance, using trucks as an example, specific designs of tires may be used to help the truck travel on paved or non-paved roads under normal conditions, mud conditions, snow conditions, rain conditions, as well as other conditions. As will be discussed below, known tires may have problems, such as insufficient grip, wheel skidding, insufficient climbing ability, poor passing performance on non-paved roads, such as muddy roads and rocky roads, easy puncture of the tread and easy blasting of the sidewall in environments such as gravel roads, mountain roads, and mining areas. As will be discussed below, the tire of the present disclosure may advantageously provide better grip performance, improve the passing performance of non-paved roads, provide higher puncture resistance and improve tire safety performance.

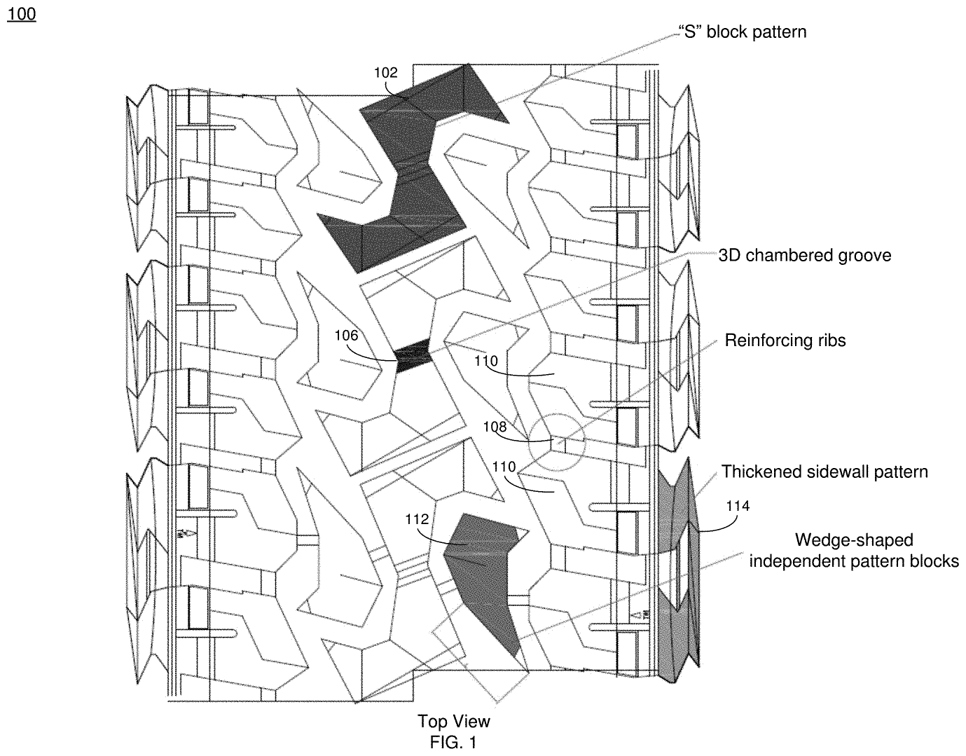

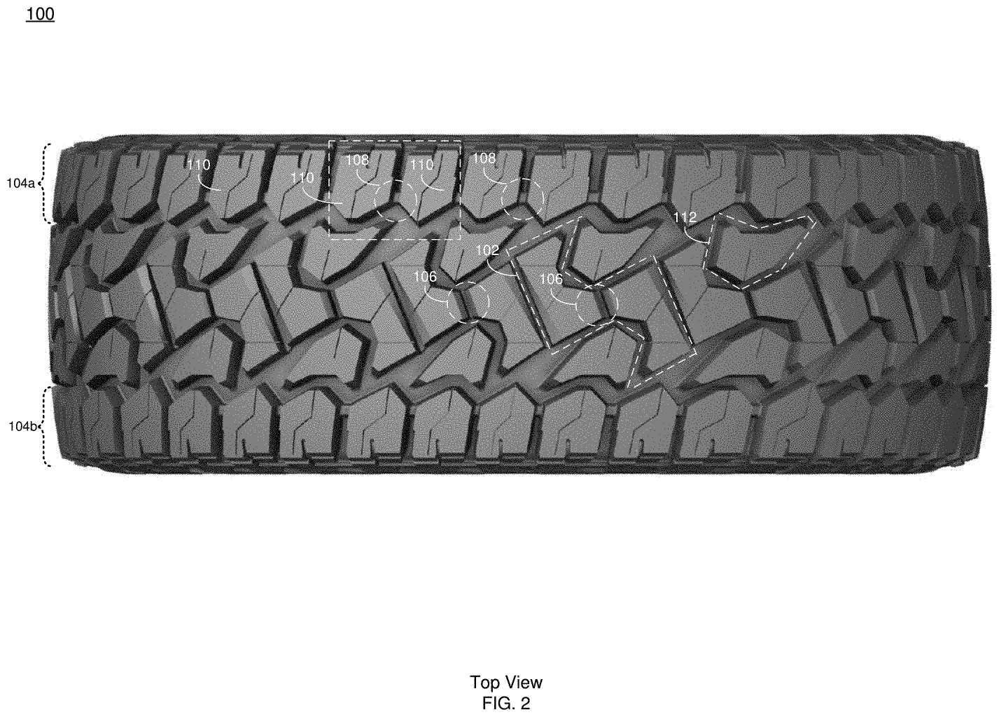

As discussed above and referring also at least to the example implementations of FIGS. 1-2, a tire may include but is not limited to a plurality of block patterns, wherein the plurality of block patterns may repeat around a circumference of the tire. The tire may further include a three dimensional chambered groove in the plurality of block patterns. The tire may further include a plurality of independent pattern blocks.

In some implementations, a tire may include a plurality of block patterns, wherein the plurality of block patterns may repeat around a circumference of the tire. For example, and referring at least to the example implementation of FIGS. 1-2, a tire (e.g., tire 100) is shown. As can be seen from FIGS. 1-2, one example of the block pattern (e.g., block pattern 102 and also referred to as pattern block 102) shows that the plurality of block patterns may repeat around a circumference of tire 100. As can also be seen, the plurality of block patterns may have an S shape, with pointed edges at either end (e.g., 30°-35° inclined large blocks in the center of the tread and 40°-55° hook-shaped sharp-angled blocks in the opposite direction). In some implementations, in addition to better aesthetics, the large “S” block pattern 102 may provide good grip performance regardless of forward or reverse motion. In some implementations, the plurality of block patterns 102 may be located between a left shoulder and a right shoulder. For instance, block patterns 102 may be located between left shoulder 104a and right shoulder 104b.

In some implementations, an angle of the pattern block may be between 5°-45° (e.g., 30° ˜35°). For instance, through the special pattern design, the optimal angle of pattern block 102 obtained from many experiments (e.g., 3D modeling analysis and finite element FEA analysis) may be selected to improve the grip performance and passing performance of tire 100. It will be appreciated that slight variations in the angle of pattern block 102 may be used without departing from the scope of the present disclosure.

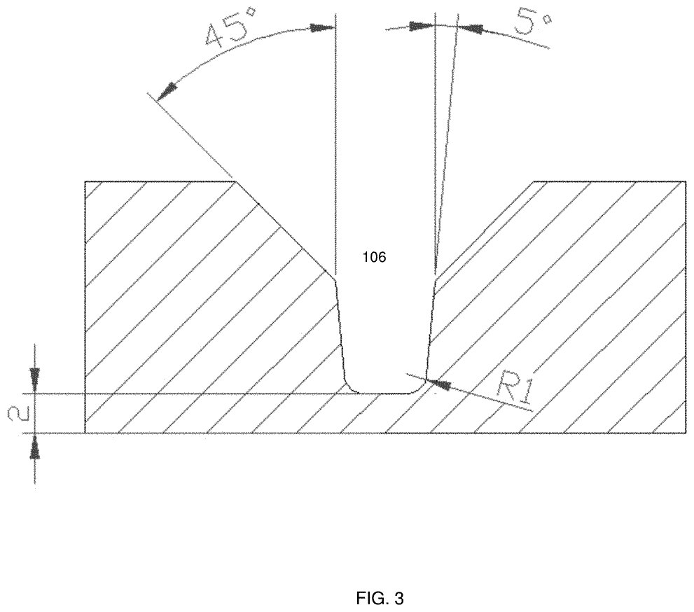

In some implementations, the tire may further include a three dimensional chambered groove in the plurality of block patterns. For instance, tire 100 may include a three dimensional chambered groove (e.g., chambered groove 106). In some implementations, chambered groove 106 may be located in a middle portion of each block pattern 102 of the plurality of block patterns. For example, as shown in FIGS. 1-3, chambered groove 106 separates each half of block pattern 102. In some implementations, chambered groove 106 may be most narrow in a middle portion of the three dimensional chambered groove, thereby taking on somewhat of an hour glass shape. A more detailed example of chambered groove 106 is shown in FIG. 3. By having chambered groove 106 in the middle of block pattern 102, this may effectively prevent sharp objects from inflicting stab/puncture wounds in tire 100, and may also have a certain self-cleaning ability, so as to continuously provide the ability to discharge rocks and mud. For example, whenever sand enters the Y-shaped groove (e.g., chambered groove 106), due to the large opening of the Y-shaped groove, it is easy to discharge the sand under the deformation and extrusion of the tire rolling block, so as to achieve the self-cleaning effect; in addition, due to the Y-shaped groove the space at the bottom of the groove is small, and sharp objects are not easy to penetrate, thereby improving the puncture resistance.

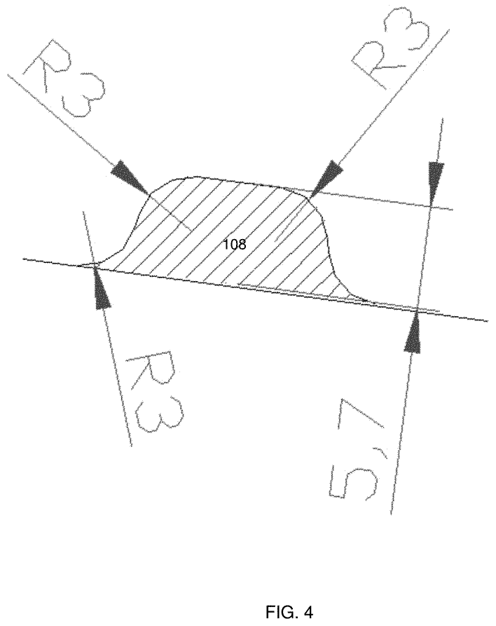

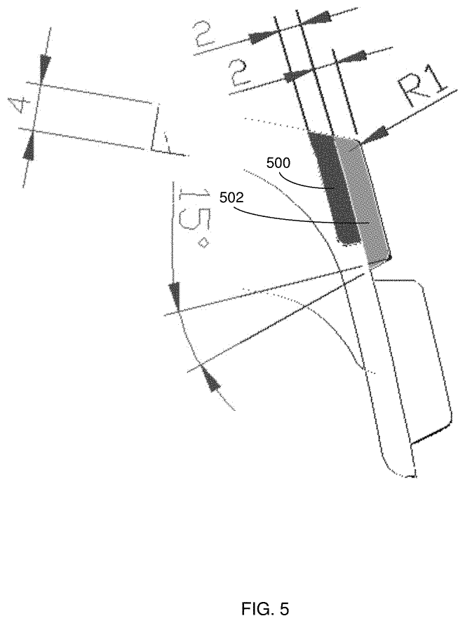

In some implementations, tire 100 may further include a plurality of reinforcing ribs. For example, as shown in FIGS. 1-2 and 4, tire 100 is shown with a reinforcing rib (e.g., reinforcing rib 108). Reinforcing ribs 108 may be located at a bottom portion of a shoulder groove, wherein one reinforcing rib of the plurality of reinforcing ribs connects two shoulder blocks. For example, tire 100 may include a plurality of shoulder blocks, such as shoulder blocks 110. FIG. 2 shows two such shoulder blocks (shown as a “W” shoulder design) connected by reinforcing rib 108. In some implementations, reinforcing ribs 108 are designed at the bottom of the shoulder groove to strengthen the overall rigidity of the shoulder and significantly improve the tire handling performance. The “W” shoulder design may improve tire climbing performance. For example, as shown in FIG. 5, at the widest point of the tire shoulder, half of pattern 500 is recessed by 2 mm, and half of pattern 502 is protruding by 2 mm, forming a W-shaped zigzag block design, thereby improving tire grip and improving passing performance.

In some implementations, tire 100 may further include a plurality of independent pattern blocks. For instance, as shown in FIGS. 1-2, tire 100 may include a plurality of independent pattern blocks, such as independent pattern block 112. In some implementations, each of independent pattern blocks 112 may have a wedge shape. For instance, the wedge shape may be widest at a top part of the wedge shape and narrowest at a bottom part of the wedge shape. Pattern block 112 may be in the shape of a C, the end of the C shape may have a sharp angle of, e.g., 50 mm-70 mm, and the angle of the sharp corner may be, e.g., 15°-30°; similar to a horseshoe with sharp corners. Advantageously, the super-long “wedge” shaped independent pattern blocks may increase the pressure per unit area, penetrate the road better, and provide stronger grip. Because pattern blocks 112 have 50 mm-70 mm sharp corners, the sharp corner blocks have a small area, so under the same weight, the smaller the area, the greater the pressure, so it can provide higher grip.

In some implementations, tire 100 may further include a sidewall pattern with a thickness between, e.g., 2.00 mm-4.00 mm. For instance, and referring at least to the example implementation of FIG. 1, an example sidewall pattern 114 is shown. In the example, thickened sidewall pattern on the sidewall may effectively prevent collision and puncture, and improve the safety of the tire on complex road conditions. Usually the thinnest part of the radial tire is below the shoulder/the uppermost part of the sidewall. Therefore, when normal tires are running on non-paved roads, they are prone to impact damage at the thinnest part; therefore, sidewall pattern 114 blocks are designed to strengthen this part.

In some implementations, sidewall pattern 114 may include at least 3 layers of high modulus low shrinkage polymer cords. For example, some designs of the present disclosure may use 3 layers of 1500D/2 E100 high modulus low shrinkage polyester cord, whereas ordinary tires generally use 1 layer or 2 layers. Advantageously, the strengthened and deepened sidewall pattern design and the use of 3 layers of high modulus low shrinkage polymer cords may thus increase the sidewall strength, thereby addressing the example problem of having the sidewall too easily burst. The advantages of high modulus and low shrinkage polyester cord fabrics may be, e.g.: low elongation, high initial modulus, good dimensional stability, impact resistance around at least 4 times higher than nylon, and excellent heat resistance. In some implementations, tire 100 may further include a belt steel wire and a double-layer crown belt. Some example designs may use 2 layers of ultra-high-strength belt steel wire F70 (2+2×0.35ST), and whereas most common tires generally use HT steel wire, the design of the present disclosure may use ST type steel wire. Advantageously, the use of ultra-high-strength belt steel wire and double-layer crown belt may be used to strengthen the performance of tire tread puncture resistance. Compared with HT type steel wire, ST type steel wire has higher tensile strength, lighter weight and easier adhesion to rubber, so it can improve tire safety performance.

In some implementations, tire 100 may be a bias tire. For example, tire 100 may be a radial tire that allows the sidewall and the tread to function as two independent features of tire 100. A bias tire may consist of multiple rubber plies overlapping each other. The crown and sidewalls may be interdependent, and thus, performance of non-paved roads may be increased by using bias tires with large blocks as shown.

In some implementations, tire 100 may be a truck and bus radial tire (also referred to herein as a TBR tire). For instance, the improvement of tire grip and performance may be addressed by adopting a TBR structure and bias tire pattern.

General:

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A, B, and C” (and the like) should be interpreted as covering only A, only B, only C, or any combination of the three, unless the context clearly indicates otherwise. It will be further understood that the terms “comprises” and/or “comprising,” when used in this specification, specify the presence of stated features, integers, elements, and/or components, but do not preclude the presence or addition of one or more other features, integers, elements, components, and/or groups thereof.

The corresponding structures, materials, acts, and equivalents (e.g., of all means or step plus function elements) that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A tire comprising:
a plurality of block patterns, wherein the plurality of block patterns repeat around a circumference of the tire;
a three dimensional chambered groove in the plurality of block patterns; and
a plurality of independent pattern blocks.

2. The tire of claim 1 wherein the plurality of block patterns have an S shape.

3. The tire of claim 1 wherein the plurality of block patterns are located between a left shoulder and a right shoulder.

4. The tire of claim 1 wherein the three dimensional chambered groove is located in a middle portion of each block pattern of the plurality of block patterns.

5. The tire of claim 4 wherein the three dimensional chambered groove is most narrow in a middle portion of the three dimensional chambered groove.

6. The tire of claim 1 wherein the plurality of independent pattern blocks has a wedge shape.

7. The tire of claim 6 wherein the wedge shape is widest at a top part of the wedge shape and narrowest at a bottom part of the wedge shape.

8. The tire of claim 1 further comprising a plurality of reinforcing ribs.

9. The tire of claim 7 wherein the plurality of reinforcing ribs are located at a bottom portion of a shoulder groove, and wherein one reinforcing rib of the plurality of reinforcing ribs connects two shoulder blocks.

10. The tire of claim 1 further comprising a sidewall pattern with a thickness between 2.0 mm-4.0 mm.

11. The tire of claim 1 wherein an angle of the pattern block is between 5°-45°.

12. The tire of claim 10 wherein the sidewall pattern includes at least 3 layers of high modulus low shrinkage polymer cords.

13. The tire of claim 1 further comprising belt steel wire and a double-layer crown belt.

14. The tire of claim 1 wherein the tire is a bias tire.

15. The tire of claim 1 wherein the tire is a truck and bus radial tire.

16. A tire comprising:
a plurality of block patterns, wherein the plurality of block patterns repeat around a circumference of the tire;
a three dimensional chambered groove in the plurality of block patterns, wherein the three dimensional chambered groove is located in a middle portion of each block pattern of the plurality of block patterns;
a plurality of independent pattern blocks; and
a plurality of reinforcing ribs located at a bottom portion of a shoulder groove, wherein one reinforcing rib of the plurality of reinforcing ribs connects two shoulder blocks.

17. The tire of claim 16 further comprising a sidewall pattern with a thickness between 2.0 mm-4.0 mm.

18. The tire of claim 16 wherein an angle of the pattern block is between 5°-45°.

19. The tire of claim 17 wherein the sidewall pattern includes at least 3 layers of high modulus low shrinkage polymer cords.

20. The tire of claim 16 further comprising belt steel wire and a double-layer crown belt.
